(19) United States
(12) Patent Application Publication
(10) Pub. No.: US 2023/0345247 A1
(43) Pub. Date: Oct. 26, 2023

(54) HIERARCHICAL CONSENT IN A COMMUNICATION NETWORK

(71) Applicant: Nokia Technologies Oy, Espoo (FI)

(72) Inventors: Colin KAHN, Morris Plains, NJ (US); Saurabh KHARE, Bangalore (IN); Gerald KUNZMANN, Munich (DE)

(21) Appl. No.: 18/306,147

(22) Filed: Apr. 24, 2023

Related U.S. Application Data
(60) Provisional application No. 63/334,262, filed on Apr. 25, 2022.

(51) Int. Cl. H04W 12/08; H04L 9/40

(52) U.S. Cl. CPC H04W 12/08; H04L 63/20

(57) ABSTRACT

Techniques for user consent in a communication network are disclosed. For example, a method comprises receiving, at a network entity of a communication network, a first level user consent for a first level data type for a first level purpose. The method further comprises applying, at the network entity, at least one hierarchical consent policy to the first level user consent to determine whether the first level user consent implies a second level user consent for a second level data type for a second level purpose.

### FIELD

The field relates generally to communication networks, and more particularly, but not exclusively, to security management in such communication networks.

### BACKGROUND

This section introduces aspects that may be helpful in facilitating a better understanding of the inventions. Accordingly, the statements of this section are to be read in this light and are not to be understood as admissions about what is in the prior art or what is not in the prior art.

Fourth generation (4G) wireless mobile telecommunications technology, also known as Long Term Evolution (LTE) technology, was designed to provide high capacity mobile multimedia with high data rates particularly for human interaction. Next generation or fifth generation (5G) technology is intended to be used not only for human interaction, but also for machine type communications in so-called Internet of Things (IoT) networks.

While 5G networks are intended to enable massive IoT services (e.g., very large numbers of limited capacity devices) and mission-critical IoT services (e.g., requiring high reliability), improvements over legacy mobile communication services are supported in the form of enhanced mobile broadband (eMBB) services providing improved wireless Internet access for mobile devices.

In an example communication system, user equipment (5G UE in a 5G network or, more broadly, a UE) such as a mobile terminal (subscriber) communicates over an air interface with a base station or access point of an access network referred to as a 5G AN in a 5G network. The access point (e.g., gNB) is illustratively part of an access network of the communication system. For example, in a 5G network, the access network referred to as a 5G AN is described in 5G Technical Specification (TS) 23.501, entitled “Technical Specification Group Services and System Aspects; System Architecture for the 5G System,” and TS 23.502, entitled “Technical Specification Group Services and System Aspects; Procedures for the 5G System (5GS),” the disclosures of which are incorporated by reference herein in their entireties. In general, the access point (e.g., gNB) provides access for the UE to a core network (CN or 5GC), which then provides access for the UE to other UEs and/or a data network such as a packet data network (e.g., Internet).

TS 23.501 goes on to define a 5G Service-Based Architecture (SBA) which models services as network functions (NFs) that communicate with each other using representational state transfer application programming interfaces (Restful APIs).

Furthermore, 5G Technical Specification (TS) 33.501, entitled “Technical Specification Group Services and System Aspects; Security Architecture and Procedures for the 5G System,” the disclosure of which is incorporated by reference herein in its entirety, further describes security management details associated with a 5G network.

Security management is an important consideration in any communication system. However, due to continuing attempts to improve the architectures and protocols associated with a 5G network in order to increase network efficiency and/or subscriber convenience, security management issues associated with data use consent can present a significant challenge.

### SUMMARY

Illustrative embodiments provide techniques for user consent in a communication network.

For example, in one illustrative embodiment, a method comprises receiving, at a network entity of a communication network, a first level user consent for a first level data type for a first level purpose. The method further comprises applying, at the network entity, at least one hierarchical consent policy to the first level user consent to determine whether the first level user consent implies a second level user consent for a second level data type for a second level purpose.

Further illustrative embodiments are provided in the form of a non-transitory computer-readable storage medium having embodied therein executable program code that when executed by a processor causes the processor to perform the above steps. Still further illustrative embodiments comprise apparatus with a processor and a memory configured to perform the above steps.

Advantageously, illustrative embodiments provide a hierarchical consent framework comprising a mapping between a user comprehendible data type for which a user grants sharing permission for a user comprehendible purpose and technology (e.g., 5GS) specific purposes and data types to be shared.

These and other features and advantages of embodiments described herein will become more apparent from the accompanying drawings and the following detailed description.

### BRIEF DESCRIPTION OF THE DRAWINGS

FIG. 1 illustrates a communication system with which one or more illustrative embodiments may be implemented.

FIG. 2 illustrates user equipment and network entities with which one or more illustrative embodiments may be implemented.

FIG. 3 illustrates a hierarchical consent framework for use in a communication network according to an illustrative embodiment.

FIG. 4 illustrates a hierarchical consent methodology for use in a communication network according to an illustrative embodiment.

FIG. 5 illustrates a hierarchical consent methodology for use in a communication network according to another illustrative embodiment.

### DETAILED DESCRIPTION

Embodiments will be illustrated herein in conjunction with example communication systems and associated techniques for security management in communication systems. It should be understood, however, that the scope of the claims is not limited to particular types of communication systems and/or processes disclosed. Embodiments can be implemented in a wide variety of other types of communication systems, using alternative processes and operations. For example, although illustrated in the context of wireless cellular systems utilizing 3GPP system elements such as a 3GPP next generation system (5G), the disclosed embodiments can be adapted in a straightforward manner to a variety of other types of communication systems.

In accordance with illustrative embodiments implemented in a 5G communication system environment, one or more 3GPP technical specifications (TS) and technical reports (TR) may provide further explanation of network elements/functions and/or operations that may interact with parts of the inventive solutions, e.g., the above-referenced 3GPP TS 23.501 and 3GPP TS 33.501. Other 3GPP TS/TR documents may provide other details that one of ordinary skill in the art will realize. For example, TS 23.288 entitled “Technical Specification Group Services and System Aspects; Architecture Enhancements for 5G System (5GS) to Support Network Data Analytics Services” and TR 33.867 entitled “Technical Specification Group Services and System Aspects; Study on User Consent for 3GPP Services;” the disclosures of which are incorporated by reference herein in their entireties, may also be mentioned below in the context of some illustrative embodiments. However, while well-suited for 5G-related 3GPP standards, embodiments are not necessarily intended to be limited to any particular standards.

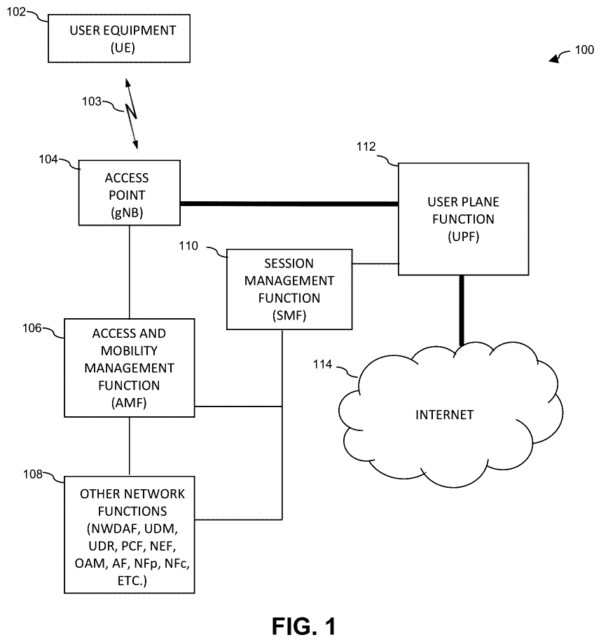

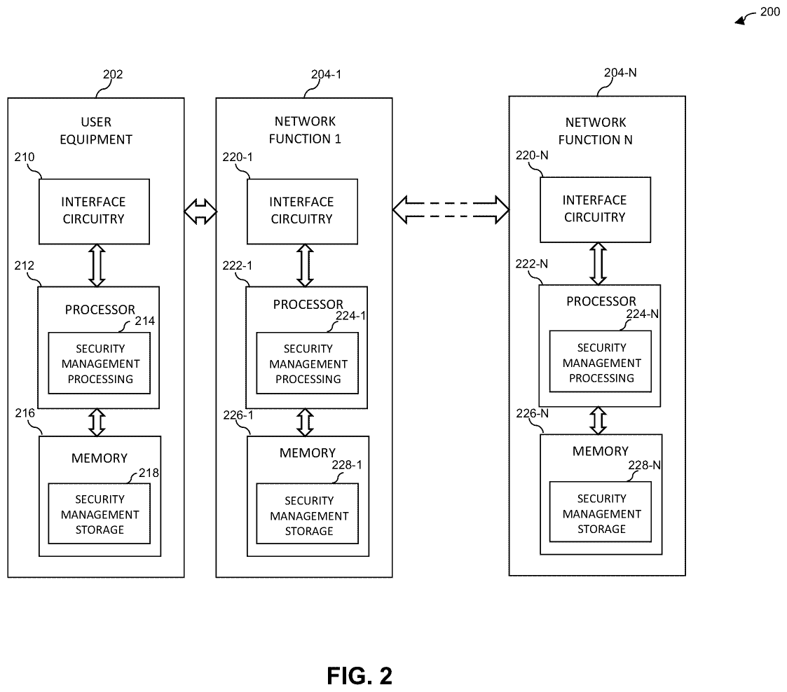

Prior to describing illustrative embodiments, a general description of certain main components of a 5G network will be described below in the context of FIGS. 1 and 2.

FIG. 1 shows a communication system 100 within which illustrative embodiments are implemented. It is to be understood that the elements shown in communication system 100 are intended to represent main functions provided within the system, e.g., UE access functions, mobility management functions, authentication functions, serving gateway functions, etc. As such, the blocks shown in FIG. 1 reference specific elements in 5G networks that provide these main functions. However, other network elements may be used to implement some or all of the main functions represented. Also, it is to be understood that not all functions of a 5G network are depicted in FIG. 1. Rather, at least some functions that facilitate an explanation of illustrative embodiments are represented. Subsequent figures may depict some additional elements/functions (i.e., network entities).

Accordingly, as shown, communication system 100 comprises user equipment (UE) 102 that communicates via an air interface 103 with an access point (gNB) 104. It is to be understood that UE 102 may use one or more other types of access points (e.g., access functions, networks, etc.) to communicate with the 5G core other than a gNB. By way of example only, the access point 104 may be any 5G access network, an untrusted non-3GPP access network that uses an N3IWF (Non-3GPP Interworking Function), a trusted non-3GPP network that uses a TNGF (Trusted Non-3GPP Gateway Function) or wireline access that uses a W-AGF (Wireline Access Gateway Function) or may correspond to a legacy access point (e.g., eNB).

The UE 102 may be a mobile station, and such a mobile station may comprise, by way of example, a mobile telephone, a computer, an IoT device, or any other type of communication device. The term “user equipment” as used herein is therefore intended to be construed broadly, so as to encompass a variety of different types of mobile stations, subscriber stations or, more generally, communication devices, including examples such as a combination of a data card inserted in a laptop or other equipment such as a smart phone. Such communication devices are also intended to encompass devices commonly referred to as access terminals.

In one embodiment, UE 102 is comprised of a Universal Integrated Circuit Card (UICC) part and a Mobile Equipment (ME) part. The UICC is the user-dependent part of the UE and contains at least one Universal Subscriber Identity Module (USIM) and appropriate application software. The USIM securely stores a permanent subscription identifier and its related key, which are used to uniquely identify and authenticate subscribers to access networks. The ME is the user-independent part of the UE and contains terminal equipment (TE) functions and various mobile termination (MT) functions.

Note that, in one example, the permanent subscription identifier is an International Mobile Subscriber Identity (IMSI) unique to the UE. In one embodiment, the IMSI is a fixed 15-digit length and consists of a 3-digit Mobile Country Code (MCC), a 3-digit Mobile Network Code (MNC), and a 9-digit Mobile Station Identification Number (MSIN). In a 5G communication system, an IMSI is referred to as a Subscription Permanent Identifier (SUPI). In the case of an IMSI as a SUPI, the MSIN provides the subscriber identity. Thus, only the MSIN portion of the IMSI typically needs to be encrypted. The MNC and MCC portions of the IMSI provide routing information, used by the serving network to route to the correct home network. When the MSIN of a SUPI is encrypted, it is referred to as Subscription Concealed Identifier (SUCI). Another example of a SUPI uses a Network Access Identifier (NAI). NAI is typically used for IoT communication.

The access point 104 is illustratively part of an access network of the communication system 100. Such an access network may comprise, for example, a 5G System having a plurality of base stations.

Further, the access point 104 in this illustrative embodiment is operatively coupled to an Access and Mobility Management Function (AMF) 106. In a 5G network, the AMF supports, inter alia, mobility management (MM) and security anchor (SEAF) functions.

AMF 106 in this illustrative embodiment is operatively coupled to (e.g., uses the services of) other network functions 108. As shown, some of these other network functions 108 include, but are not limited to, a Network Data Analytics Function (NWDAF), a Unified Data Management (UDM) function, a Unified Data Repository (UDR), a Policy Control Function (PCF), a Network Exposure Function (NEF), an Operations, Administration, and Maintenance (OAM) function, an Application Function (AF), and other network functions that can act as service producers (NFp) and/or service consumers (NFc). Note that any network function can be a service producer for one service and a service consumer for another service. Further, when the service being provided includes data, the data-providing NFp is referred to as a data producer, while the data-requesting NFc is referred to as a data consumer. A data producer may also be an NF that generates data by modifying or otherwise processing data produced by another NF.

Note that a UE, such as UE 102, is typically subscribed to what is referred to as a Home Public Land Mobile Network (HPLMN) in which some or all of the functions 106 and 108 reside. Alternatively the UE, such as UE 102, may receive services from a non-Public Network (NPN) where these functions may reside. The HPLMN is also referred to as the Home Environment (HE). If the UE is roaming (not in the HPLMN), it is typically connected with a Visited Public Land Mobile Network (VPLMN) also referred to as a visited network, while the network that is currently serving the UE is also referred to as a serving network. In the roaming case, some of the network functions 106 and 108 can reside in the VPLMN, in which case, functions in the VPLMN communicate with functions in the HPLMN as needed. However, in a non-roaming scenario, mobility management functions 106 and the other network functions 108 reside in the same communication network, i.e. HPLMN. Embodiments described herein are not limited by which functions reside in which PLMN (i.e., HPLMN or VPLMN).

The access point 104 is also operatively coupled (via one or more of functions 106 and/or 108) to a Session Management Function (SMF) 110, which is operatively coupled to a User Plane Function (UPF) 112. UPF 112 is operatively coupled to a Packet Data Network, e.g., Internet 114. Note that the thicker solid lines in this figure denote a user plane (UP) of the communication network, as compared to the thinner solid lines that denote a control plane (CP) of the communication network. It is to be appreciated that network 114 in FIG. 1 may additionally or alternatively represent other network infrastructures including, but not limited to, cloud computing infrastructure and/or edge computing infrastructure. Further typical operations and functions of such network elements are not described here since they are not the focus of the illustrative embodiments and may be found in appropriate 3GPP 5G documentation. Note that functions shown in 106, 108, 110 and 112 are examples of network functions (NFs).

It is to be appreciated that this particular arrangement of system elements is an example only, and other types and arrangements of additional or alternative elements can be used to implement a communication system in other embodiments. For example, in other embodiments, the system 100 may comprise other elements/functions not expressly shown herein.

Accordingly, the FIG. 1 arrangement is just one example configuration of a wireless cellular system, and numerous alternative configurations of system elements may be used. For example, although only single elements/functions are shown in the FIG. 1 embodiment, this is for simplicity and clarity of description only. A given alternative embodiment may of course include larger numbers of such system elements, as well as additional or alternative elements of a type commonly associated with conventional system implementations.

It is also to be noted that while FIG. 1 illustrates system elements as singular functional blocks, the various subnetworks that make up the 5G network are partitioned into so-called network slices. Network slices (network partitions) are logical networks that provide specific network capabilities and network characteristics that can support a corresponding service type, optionally using network function virtualization (NFV) on a common physical infrastructure. With NFV, network slices are instantiated as needed for a given service, e.g., eMBB service, massive IoT service, and mission-critical IoT service. A network slice or function is thus instantiated when an instance of that network slice or function is created. In some embodiments, this involves installing or otherwise running the network slice or function on one or more host devices of the underlying physical infrastructure. UE 102 is configured to access one or more of these services via gNB 104.

FIG. 2 is a block diagram illustrating computing architectures for various participants in methodologies according to illustrative embodiments. More particularly, system 200 is shown comprising user equipment (UE) 202 and a plurality of network entities 204-1, . . . 204-N. For example, in illustrative embodiments and with reference back to FIG. 1, UE 202 can represent UE 102, while network entities 204-1, . . . , 204-N can represent functions 106 and 108. It is to be appreciated that the UE 202 and network entities 204-1, . . . 204-N are configured to interact to provide security management and other techniques described herein.

The user equipment 202 comprises a processor 212 coupled to a memory 216 and interface circuitry 210. The processor 212 of the user equipment 202 includes a security management processing module 214 that may be implemented at least in part in the form of software executed by the processor. The processing module 214 performs security management described in conjunction with subsequent figures and otherwise herein. The memory 216 of the user equipment 202 includes a security management storage module 218 that stores data generated or otherwise used during security management operations.

Each of the network entities (individually or collectively referred to herein as 204) comprises a processor 222 (222-1, . . . , 222-N) coupled to a memory 226 (226-1, . . . , 226-N) and interface circuitry 220 (220-1, . . . , 220-N). Each processor 222 of each network entity 204 includes a security management processing module 224 (224-1, . . . , 224-N) that may be implemented at least in part in the form of software executed by the processor 222. The processing module 224 performs security management operations described in conjunction with subsequent figures and otherwise herein. Each memory 226 of each network entity 204 includes a security management storage module 228 (228-1, . . . , 228-N) that stores data generated or otherwise used during security management operations.

The processors 212 and 222 may comprise, for example, microprocessors such as central processing units (CPUs), application-specific integrated circuits (ASICs), digital signal processors (DSPs) or other types of processing devices, as well as portions or combinations of such elements.

The memories 216 and 226 may be used to store one or more software programs that are executed by the respective processors 212 and 222 to implement at least a portion of the functionality described herein. For example, security management operations and other functionality as described in conjunction with subsequent figures and otherwise herein may be implemented in a straightforward manner using software code executed by processors 212 and 222.

A given one of the memories 216 and 226 may therefore be viewed as an example of what is more generally referred to herein as a computer program product or still more generally as a processor-readable storage medium that has executable program code embodied therein. Other examples of processor-readable storage media may include disks or other types of magnetic or optical media, in any combination. Illustrative embodiments can include articles of manufacture comprising such computer program products or other processor-readable storage media.

Further, the memories 216 and 226 may more particularly comprise, for example, electronic random-access memory (RAM) such as static RAM (SRAM), dynamic RAM (DRAM) or other types of volatile or non-volatile electronic memory. The latter may include, for example, non-volatile memories such as flash memory, magnetic RAM (MRAM), phase-change RAM (PC-RAM) or ferroelectric RAM (FRAM). The term “memory” as used herein is intended to be broadly construed, and may additionally or alternatively encompass, for example, a read-only memory (ROM), a disk-based memory, or other type of storage device, as well as portions or combinations of such devices.

The interface circuitries 210 and 220 illustratively comprise transceivers or other communication hardware or firmware that allows the associated system elements to communicate with one another in the manner described herein.

It is apparent from FIG. 2 that user equipment 202 and plurality of network entities 204 are configured for communication with each other as security management participants via their respective interface circuitries 210 and 220. This communication involves each participant sending data to and/or receiving data from one or more of the other participants. The term “data” as used herein is intended to be construed broadly, so as to encompass any type of information that may be sent between participants including, but not limited to, identity data, key pairs, key indicators, security management messages, registration request/response messages and data, request/response messages, authentication request/response messages and data, metadata, control data, audio, video, multimedia, consent data, other messages, etc.

It is to be appreciated that the particular arrangement of components shown in FIG. 2 is an example only, and numerous alternative configurations may be used in other embodiments. For example, any given network element/function can be configured to incorporate additional or alternative components and to support other communication protocols.

Other system elements such as gNB 104, SMF 110, and UPF 112 may each be configured to include components such as a processor, memory and network interface. These elements need not be implemented on separate stand-alone processing platforms, but could instead, for example, represent different functional portions of a single common processing platform.

More generally, FIG. 2 can be considered to represent processing devices configured to provide respective security management functionalities and operatively coupled to one another in a communication system.

As mentioned above, the 3GPP TS 23.501 defines the 5G core network architecture as service-based, e.g., Service-Based Architecture (SBA). It is realized herein that in deploying different NFs, there can be many situations where an NF may need to interact with an entity external to the SBA-based 5G core network (e.g., including the corresponding PLMN(s), e.g., HPLMN and VPLMN). Thus, the term “internal” as used herein illustratively refers to operations and/or communications within the SBA-based 5G core network (e.g., SBA-based interfaces) and the term “external” illustratively refers to operations and/or communications outside the SBA-based 5G core network (non-SBA interfaces).

Given the above general description of some features of a 5G network, problems with existing security (e.g., data use consent) approaches and solutions proposed in accordance with illustrative embodiments will now be described herein below.

The above-referenced 3GPP TS 23.288 specifies that the NWDAF obtains data from data sources such as the AMF, SMF, PCF, UDM, AF, and OAM and provides network analytics to one or more consumers (NFc). Further, user consent is mentioned therein whereby, depending on local regulation requirements, user consent for UE related data collection and usage of collected data may be required. User consent is defined therein for two specific purposes, i.e., analytics and analytics model training. User consent information (granted or not granted) is stored in the UDR/UDM subscription data and is retrieved by the NWDAF prior to collecting UE related data. If consent is granted, the NWDAF subscribes to the UDM for notifications of changes to user consent. If a notification is received indicating user consent is no longer granted for a user for which data has been collected, the NWDAF halts data collection for that UE.

Notwithstanding the mention of user consent as described above in 3GPP TS 23.288, there currently is no 3GPP-specified mechanism by which user consent to gather and use data is obtained. It is assumed that the UDM is provisioned with consent to use user data for model training and/or analytics. Today, consent to use user data is usually granted in user agreements presented when users request use of specific applications or services. In exchange for use of those applications or services, the user may offer or be required to grant some level of permission. It is realized herein that permission should be solicited in a way such that both the data gathered and the purpose for which it is used is understandable to a user. For example, consent may be asked to use location information to improve application performance in exchange for using a navigation application, or browsing history, contact list and photos may be shared for advertising purposes in exchange for using a social network application. In these cases, it is clear in user understandable language both the data being shared, and the purpose of sharing, and hence the user can provide informed consent.

This is not currently the case for consent related to analytics and model training. More particularly, it is realized herein that the purpose for model training and/or network analytics is currently understandable only to engineers familiar with 3GPP TS 23.288, while to others it is obscure. Furthermore, the standard supports only blanket permission to use data for any analytics or model training. There is no way for a user to know that permission is being granted, for example, to gather data for analytics regarding their location (mobility analytics) or for analytics related to the communication patterns (communication analytics), and there is no way for the user to specify consent to gather data for one versus the other. Even if there were a way for the user to consent to use of their data for specific NWDAF analytics or model training, the 3GPP definitions are difficult for users to understand, making it difficult to support the important premise that the user consent be informed consent.

Still further, the data gathered is also obscure to users. It is realized herein that, currently, blanket permission is granted to gather all data. However, there is a very wide scope to user data consumed by the NWDAF and data are often defined in a way that is difficult for users to understand. For example, user input data for analytics may include mobility registration updates and UE access behavior trends due to registration management (RM) and connection management (CM) state transitions in an AMF. Users cannot be expected to understand the meaning of this data, and hence cannot provide informed consent to the NWDAF even when told what data is to be collected.

Accordingly, it is realized herein that there is a disconnect between user comprehendible consent and permissions required to gather data in the 5GS.

Illustrative embodiments overcome the above and other drawbacks associated with current consent approaches in communication networks. More particularly, illustrative embodiments provide a hierarchical consent method for mapping between a user comprehendible data type for which a user grants sharing permission for a user comprehendible purpose and technology (e.g., 5GS) specific purpose(s) and data type(s) to be shared.

User comprehendible purpose, as illustratively used herein, is the purpose for which a user shares data (e.g., marketing, network optimization, improving application functionality, improving user experience). User comprehendible data type, as illustratively used herein, indicates data the user is willing to share for the specific user comprehendible purpose. By way of example, for the purpose of marketing, the user comprehensible data type can be location data and browsing history, while for the purpose of network optimization, the user comprehensible data type can be location data and communication activity/logs.

In one or more illustrative embodiments, the hierarchical consent method provides a mapping between user comprehendible permissions to gather data for a user comprehendible purpose to permission required by 3GPP to gather data for network analytics or training of network analytics models, which is currently not easily comprehended by users. The hierarchical consent framework provides implied consent based on a policy whereby user consent granted in the user comprehendible level (i.e., a first level user consent) implies consent at a lower level (i.e., second level user consent) to grant use of data for a purpose not otherwise easily understood by users.

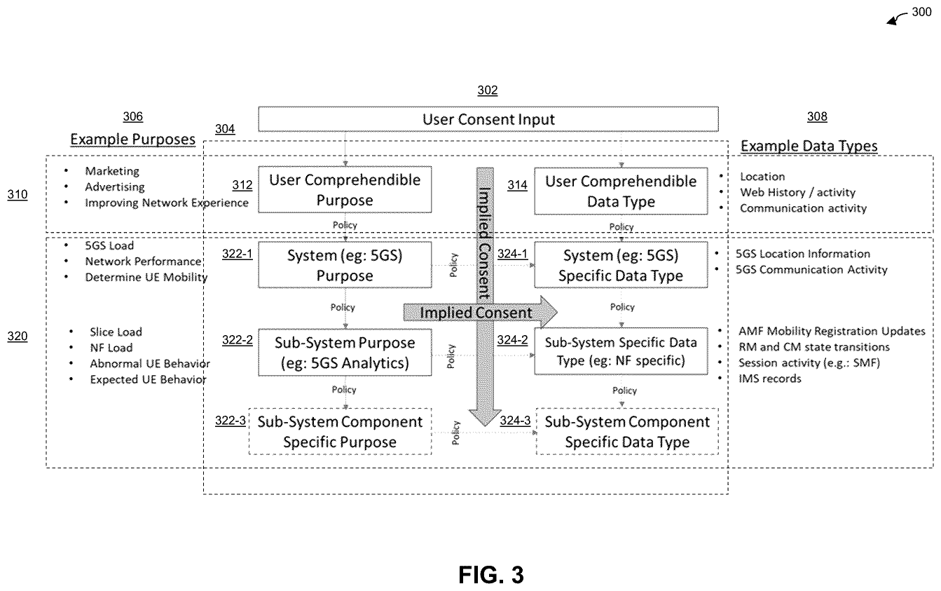

FIG. 3 illustrates a hierarchical consent framework 300 according to an illustrative embodiment. It is to be appreciated that hierarchical consent framework 300 can be implemented in one or more network functions (network entities) in the communication network in which it is implemented. By way of example only, in 5G embodiments, hierarchical consent framework 300 can be implemented as logic or functionality within one or more existing network functions, or in one or more dedicated hierarchical consent network functions.

As shown in FIG. 3, hierarchical consent framework 300 receives user consent input 302 and applies the user consent input 302 to one or more policies defined by a mapping 304 between purposes 306 and data types 308. Mapping 304 comprises a user comprehendible level 310 and a system level 320 which, itself, can have sub-levels as shown and as will be further explained.

As shown in mapping 304 at user comprehendible level 310, a user comprehendible purpose 312 maps to a user comprehendible data type 314.

Examples of user comprehendible purpose 312 include, but are not limited to, marketing, advertising, and improving network experience. Examples of user comprehendible data type 308 include, but are not limited to, location, web history/activity, and communication activity. It is to be understood that the examples of user comprehendible level 310 shown in FIG. 3 and mentioned herein are non-limiting examples and not intended to limit alternative embodiments.

As further shown in mapping 304 at system level 320: (i) at a first sub-level, a system specific purpose 322-1 maps to a system specific data type 324-1; (ii) at a second sub-level, a sub-system specific purpose 322-2 maps to a sub-system specific data type 324-2; and (iii) at a third sub-level, a sub-system component specific purpose 322-3 maps to a sub-system component specific data type 324-3.

Examples of system specific purpose 322-1 include, but are not limited to, 5GS load, network performance, and determine UE mobility. Examples of system specific data type 324-1 include, but are not limited to, 5GS location information and 5GS communication activity. Examples of sub-system specific purpose 322-2 include, but are not limited to, slice load, NF load, abnormal UE behavior, and expected UE behavior. Examples of sub-system specific data type 324-2 include, but are not limited to, AMF mobility registration updates, RM and CM state transitions, session activity (e.g., SMF), and IP Multimedia Subsystem (IMS) records. Examples of sub-system component specific purpose 322-3 and sub-system component specific data type 324-3 depend on the given sub-system with which the component is associated. It is to be understood that the sub-levels and examples of system level 320 shown in FIG. 3 and mentioned herein are non-limiting examples and not intended to limit alternative embodiments.

In accordance with illustrative embodiments, user consent granted in user comprehendible level 310 implies consent at system level 320 to grant use of data for a purpose not otherwise easily understood by users.

Implied consent may be provided from a purpose 306 to a specific data type 308. For example, if consent is provided at a system level (e.g., one of the sub-levels of the system level) for the purpose of gathering a specific analytic, then consent to gather the data needed to determine those analytics may be implied. In this way, final granularity of user consent can be achieved.

Alternatively, implied consent may be mapped separately for purpose and data type associated with that purpose. For example, if a user has provided consent for the user comprehendible purpose 312: “marketing” and user comprehendible data type(s) 314: “location” and “communication activity,” then user consent policy functionality derives the further values at the lower levels, e.g., system 322-1/324-1, sub-system 322-2/324-2, sub-system component 322-3/324-3. The policy may be based on operator preferences and can reflect country/jurisdiction specific regulations regarding privacy. So, for example, purpose: “marketing” may further imply that the purpose: “UE mobility” at the system level layer is allowed and data type: “location” may imply that 5GS location data may be gathered for this purpose.

In another example, the user may provide user comprehendible purpose 312: “marketing” and user comprehendible data type 314: “web history” (but not “location”). Then, UE behavior as a sub-system specific purpose 322-2 required for “marketing” cannot rely on “5GS location information,” but could still use “5GS communication activity” as a system specific data type 324-1.

Based on different regulations and rules of the country, mapping 304 and its associated policies can be adjusted by the operators.

For 5GS, consent information may be stored in the UDM/UDR. The stored consent information is on a system purpose level, i.e., consent to use data for analytics and/or model training purpose. In accordance with illustrative embodiments, stored information (purpose and data type) may be at a higher level (e.g., user comprehendible), in which case implied consent policy mapping is performed when the stored information is retrieved from the UDM/UDR, for example, because an NF (e.g., NWDAF) needs to determine at a lower level whether use of a user's data is allowed (e.g., use UE location data for the purpose of determining abnormal UE behavior). Alternatively, in accordance with illustrative embodiments, stored information (purpose and data type) may be at a lower level (e.g., sub-system), in which case implied consent policy mapping is performed before the information is stored in the UDM/UDR, e.g., when the user specifies their preference at the user comprehensible level.

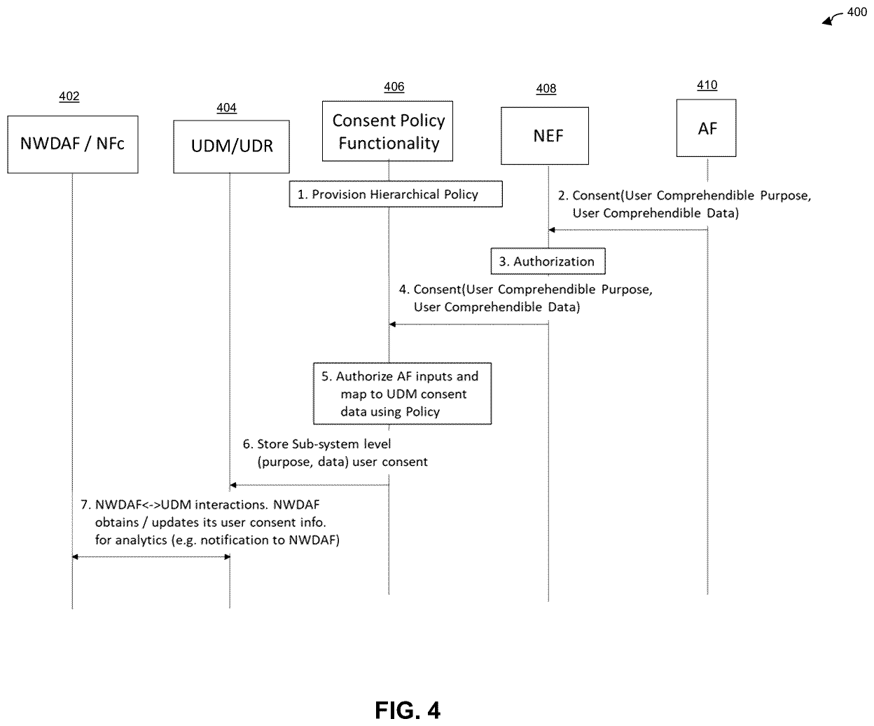

FIG. 4 illustrates a hierarchical consent methodology 400 for use in a communication network according to an illustrative embodiment. As shown, by way of example, the FIG. 4 embodiment comprises an NWDAF or any network function (NWDAF/NFc 402), a UDM/UDR 404, a consent policy functionality 406 (e.g., implementing at least a portion of hierarchical consent framework 300), an NEF 408, and an AF 410. More particularly, FIG. 4 shows an illustrative embodiment wherein a consent policy functionality 406 provides the mapping between both user comprehendible purpose and user comprehendible data type provided by an authorized application function (AF 410 exposed by NEF 408), and a 5GS purpose and a 5GS data type which are stored in the UDR (UDM/UDR 404) and used to determine whether user data can be used for the NWDAF or any network function (NWDAF/NFc 402).

It is to be appreciated that consent policy functionality 406 can be hosted on UDM/UDR 404, NEF 408, AF 410, or any network function including possibly a new network function.

When a consumer network function (NWDAF or any other NFc 402) requires user consent information, the information can be obtained from the UDM/UDR 404 and the consumer network function may update its local user consent information. UDM/UDR 404 can store the consent information per PLMN, i.e., the policy can vary from PLMN to PLMN, reflecting jurisdiction requirements and operator preferences for user consent in different networks.

Accordingly, as shown in step 1 of methodology 400, consent policy functionality 406 provisions a hierarchical policy (or policies, e.g., as per hierarchical consent framework 300).

In step 2, AF 410 provides user consent, received for a given UE (not expressly shown), for a user comprehendible purpose and user comprehendible data type to NEF 408.

NEF 408 provides authorization in step 3, and provides the user consent for the given UE for a user comprehendible purpose and user comprehendible data type to consent policy functionality 406 in step 4.

In step 5, in accordance with the hierarchical policy provisioned in step 1, consent policy functionality 406 authorizes the AF 410 input(s) and maps to UDM/UDR 404 consent data using the hierarchical policy.

Consent policy functionality 406 stores the system layer (system, sub-system and/or sub-system component level purpose/data type) user consent at UDM/UDR 404 in step 6.

Step 7 depicts interaction between NWDAF/NFc 402 and UDM/UDR 404. More specifically, NWDAF/NFc 402 obtains/updates its user consent information for analytics (e.g., via GET or subscribe/notification to NWDAF) from UDM/UDR 404.

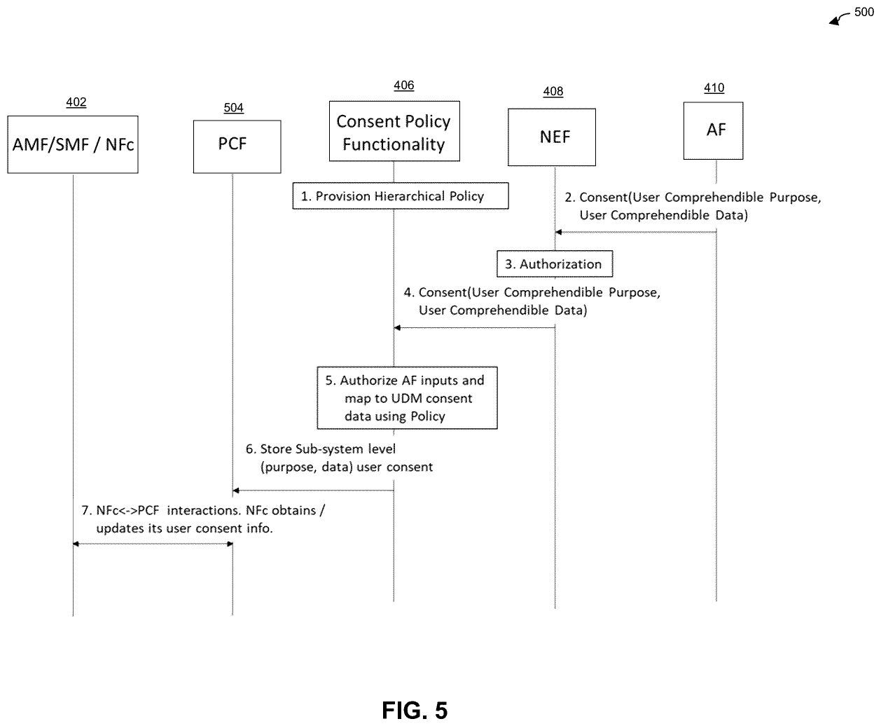

FIG. 5 shows a hierarchical consent methodology 500 as an alternative embodiment to methodology 400 of FIG. 4 wherein consent can be sent to a PCF 504 rather than UDM/UDR 404 (note that all other participants and steps of methodology 400 are the same or similar in methodology 500) after processing by consent policy functionality 406 which receives consent information from AF 410. The PCF 504 can further apply policies and provide the consent information to a consumer (e.g., AMF/SMF).

As used herein, it is to be understood that the term “communication network” in some embodiments can comprise two or more separate communication networks. Further, the particular processing operations and other system functionality described in conjunction with the diagrams described herein are presented by way of illustrative example only, and should not be construed as limiting the scope of the disclosure in any way. Alternative embodiments can use other types of processing operations and messaging protocols. For example, the ordering of the steps may be varied in other embodiments, or certain steps may be performed at least in part concurrently with one another rather than serially. Also, one or more of the steps may be repeated periodically, or multiple instances of the methods can be performed in parallel with one another.

It should again be emphasized that the various embodiments described herein are presented by way of illustrative example only and should not be construed as limiting the scope of the claims. For example, alternative embodiments can utilize different communication system configurations, user equipment configurations, base station configurations, provisioning and usage processes, messaging protocols and message formats than those described above in the context of the illustrative embodiments. These and numerous other alternative embodiments within the scope of the appended claims will be readily apparent to those skilled in the art.

What is claimed is:

1. An apparatus comprising:
at least one processor;
at least one memory including computer program code;
the at least one memory and the computer program code being configured to, with the at least one processor, cause the apparatus at least to:
receive a notification of a first level user consent for a first level data type for a first level purpose; and
apply at least one hierarchical consent policy to the first level user consent to determine whether the first level user consent implies a second level user consent for a second level data type for a second level purpose.

2. The apparatus of claim 1, wherein the first level data type comprises a user comprehendible data type and the first level purpose comprises a user comprehendible purpose, wherein the user comprehendible data type is mapped to the user comprehendible purpose.

3. The apparatus of claim 2, wherein the user comprehendible data type indicates data a user consents to share for the user comprehendible purpose.

4. The apparatus of claim 1, wherein the second level user consent applies to two or more levels of system-related data types respectively mapped to two or more levels of system-related purposes.

5. The apparatus of claim 4, wherein the two or more levels of system-related data types comprise a system data type, a sub-system data type, and a sub-system component data type, and the two or more levels of system-related purposes comprise a system purpose, a sub-system purpose, and a sub-system component purpose, wherein the system data type, the sub-system data type, and the sub-system component data type are respectively mapped to the system purpose, the sub-system purpose, and the sub-system component purpose.

6. The apparatus of claim 4, wherein the two or more levels of system-related data types respectfully indicate data shareable for at least one of an analytics purpose and an analytics model training purpose.

7. The apparatus of claim 1, wherein the at least one memory and the computer program code are further configured to, with the at least one processor, cause the apparatus to:
authorizing or denying the second level user consent based on the application of the hierarchical consent policy.

8. The apparatus of claim 7, wherein the at least one memory and the computer program code are further configured to, with the at least one processor, cause the apparatus to:
in response to the second level user consent being authorized, cause the second level user consent to be stored in a first network entity in a communication network for interaction with a second network entity in the communication network.

9. The apparatus of claim 8, wherein the first network entity comprises a unified data management-related function.

10. The apparatus of claim 8, wherein the first network entity comprises a policy control-related function.

11. The apparatus of claim 8, wherein the second network entity comprises a service consumer.

12. The apparatus of claim 11, wherein the service consumer comprises a network data analytics function.

13. The apparatus of claim 11, wherein the service consumer comprises an access and mobility management function.

14. The apparatus of claim 11, wherein the service consumer comprises a session management function.

15. The apparatus of claim 1, wherein the application of the at least one hierarchical consent policy is performed in one or more network entities in a communication network.

16. The apparatus of claim 1, wherein the first level user consent is received from an application function associated with a communication network.

17. A method comprising:
receiving, at a network entity of a communication network, a notification of a first level user consent for a first level data type for a first level purpose; and
applying, at the network entity, at least one hierarchical consent policy to the first level user consent to determine whether the first level user consent implies a second level user consent for a second level data type for a second level purpose.

18. The method of claim 17, wherein the first level data type comprises a user comprehendible data type and the first level purpose comprises a user comprehendible purpose, wherein the user comprehendible data type is mapped to the user comprehendible purpose.

19. The method of claim 18, wherein the user comprehendible data type indicates data a user consents to share for the user comprehendible purpose.

20. The method of claim 17, wherein the second level user consent applies to two or more levels of system-related data types respectively mapped to two or more levels of system-related purposes.
